(19) United States
(12) Patent Application Publication
(10) Pub. No.: US 2008/0062115 A1
(43) Pub. Date: Mar. 13, 2008

(54) System and method for predicting a failure of a backlight for an LCD display

(76) Inventor: Houston Brown, Poway, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/520,516

(22) Filed: Sep. 13, 2006

(51) Int. Cl. G09G 3/36

(52) U.S. Cl. 345/102

(57) ABSTRACT

An early warning system and method for predicting a failure of a backlight of any display that uses internal illumination, such as a liquid crystal display (LCD), digital light processing™ (DLP), or liquid crystal on silicon (LCoS). This display could be a flat screen type or a projector type. A display indicating that failure is imminent within a certain period of time is provided. A countdown display of life remaining may also be provided. Color temperature of the backlight is monitored and compared over time to form the prediction of failure. Measurements may also include measurements of individual components of light, such as the red, green, and blue components. Components may be compared individually over time to detect a color shift that reaches a threshold of prediction failure.

The invention relates generally to display devices and, more particularly, to the measurement of light output of a backlight of a display device for predicting failure of the backlight.

### BACKGROUND OF THE INVENTION

A flat panel, liquid crystal display (“LCD”) is a popular display device for conveying information. The decreased weight and size of an LCD, and its reduced power requirements, greatly increase its versatility over a cathode ray tube (“CRT”) display and other display types. However, LCDs require a source of illumination in order to see the information presented. High quality LCDs, such as transmissive color LCD units, are typically back-lit by an internal light source. That is, a backlight is placed behind liquid crystal layers to facilitate visualization of the resultant image produced by the LCD. Transflective LCD units typically rely on an internal or an external (e.g., ambient) light source while reflective LCD units rely totally on external light sources. Projection displays using either LCD or DLP (Digital Light Processing™ by Texas Instruments) typically use incandescent lamps for illumination. It is known that the color temperature of incandescent lamps increases close to the end of life because part of the filament becomes eroded and thinner and consequently hotter.

LCD units are used today in many applications including the computer industry where they are not only an excellent display choice for lap-top computers, but are also being increasingly used for desk-top computers where their reduced size makes them attractive. They are also used on many other portable electronic devices.

A transmissive liquid crystal display becomes useless when its backlight fails. The information presented by the LCD cannot easily be read, thus rendering the display essentially inoperative. Such a failure may impair the operation of a device or system associated with the display. In some cases, a backlight failure may render the device or system with which the LCD is associated completely unusable. LCDs are also used for medical equipment. They provide user interfaces for medication delivery systems and medication storage systems as well as for many other types of medical equipment. In many medical equipment applications, as in other applications, the LCD is an integral part of the equipment and cannot easily be replaced when it fails. In the case of a desk-top computer application, when the LCD fails another LCD can typically be readily obtained, connected to the computer, and the user is able to continue with his or her tasks. In the case of a lap-top computer and many medical equipment devices, the equipment itself must be disassembled, the failed LCD removed and an operational LCD be installed in its place. This can take a significant amount of effort and time and while the LCD replacement is being effected, the equipment is non-operational. For example, a backlight failure on a display associated with an infusion pump controller may require that use of the controller be discontinued until the backlight is replaced. If the entire controller can be easily replaced, the infusion pump may then be put back into use immediately with the new controller while the failed display on the first controller is being repaired, assuming a replacement controller is available and can be reprogrammed.

As a further example, a backlight failure on a display associated with an access controller of a medical supply cabinet may render that cabinet unusable for ordinary service. Such an event may require that any controlled substances stored in that cabinet, such as narcotic medications, be transferred to another supply cabinet in order to ensure that only authorized persons have access to them. In addition to the actual physical movement of the controlled medications from one cabinet to another, data of the move must be logged in the servers monitoring the location of such medications. Such a transfer activity can require a significant amount of time and in view of the already busy schedules of most healthcare workers is undesirable. In any case, a backlight failure in medical and other settings can adversely affect workflow efficiency.

Common backlights for LCD units are light emitting diodes (LEDs) and cold cathode fluorescent lamps (CCFLs). One disadvantage of CCFLs is their relative short operational life. The color temperature of light produced by CCFLs and other sources of illumination is known to shift with time. Color sensors have been used to provide automatic “white balance” adjustment to compensate for the shift in “color temperature” of light from CRT displays and backlights. In general, the “color temperature” of white light from any source of illumination correlates to the relative percentage contributions of its red, green, and blue intensity components. Relatively high color temperatures, expressed in degrees Kelvin (° K.), represent “white” having a larger blue contribution. Relatively low color temperatures represent “white” having a larger red contribution. Light detectors have also been used with LCD units to adjust the intensity of light from light sources. However, to the knowledge of the inventor, no sensors have been used to predict the imminent failure of an LCD.

All backlights will eventually fail through use or mere age. Some types of backlights will fail before other types of backlights. It is only a question of when this failure will occur. Failure of the backlight results in inoperability of the associated LCD in many or most cases. The ability to accurately predict the imminent inoperability of an LCD would provide the user an advantage in that steps could be taken ahead of time to schedule replacement or repair of the failing LCD. Where the LCD is an integral and necessary component for operation of a medical instrument and the failure of the LCD has been predicted, the instrument could be scheduled for maintenance ahead of the actual failure of the LCD during which the LCD could be replaced or repaired. With such a maintenance scheduling ability, a much higher confidence level would exist that instruments will not unexpectedly be rendered inoperative due to the backlight failure of an LCD just when the instrument is needed or is in actual operation.

Merely providing a “typical” life to a backlight in a number of days or months or years, or assigning a number of working hours to represent its life results in the operator having the added burden of having to keep track of the use of the backlight. The number of times it is turned on or off may also impact its life. Recording this data and reviewing it periodically can impose a burden on operators that they do not have time to support. Operators may take the approach that it is more efficient to simply wait until the backlight fails and then repair it than to continually record and analyze hours of service and off-and-on cycles of the backlight in an attempt to predict failure. Of course the approach of waiting for failure can have the adverse consequences discussed above where the LCD and backlight are used in a critical application.

Hence, those skilled in the art have recognized a need for a means of providing a more accurate advance warning of a backlight failure in a liquid crystal display. A need has also been recognized for an automatic system and method for providing such warning. Such a warning would lessen the negative effect on workflow efficiency from a backlight failure by allowing users to perform preventative maintenance by replacing the backlight prior to failure. This invention satisfies this and other needs.

### SUMMARY OF THE INVENTION

Briefly and in general terms, the present invention is directed to a system and method that predict the failure of a backlight for a display. In particular, there is provided a system that predicts failure of a backlight for a display, the system comprising a sensor in optical communication with the backlight, configured to take color measurements of light from the backlight, and configured to provide measurement signals representative of the light sensed during those color measurements, a memory device configured to store color measurements, and a processor in communication with the sensor and the memory, configured to receive a plurality of measurement signals that have been taken of the backlight at different times, compare a plurality of measurement signals to each other, and to provide a prediction signal of predicted failure of the backlight based on a comparison between at least two measurement signals. In more detailed aspects, the processor is further configured to store measurement signals in the memory device, access the memory device to retrieve a stored measurement signal, compare the retrieved measurement signal to a more current measurement signal, and provide the prediction signal of predicted failure of the backlight based on the comparison between the retrieved measurement signal and the more current measurement signal.

In other detailed aspects of the invention the processor is further configured to provide a failure warning signal to a display when the result of the comparison exceeds a threshold. The processor is further configured to provide a failure warning signal to illuminate a warning light when the result of the comparison exceeds a threshold. The processor is further configured to provide a life remaining signal to a display based on the comparison representative of the operational life remaining in the backlight before failure.

In yet other aspects, the sensor is configured to provide measurement signals representative of the color temperature of the light sensed from the backlight and the processor is further configured to compare a more recent color temperature measurement signal of the backlight to an older color temperature measurement signal of the backlight and provide the prediction signal of predicted failure when the difference between the more recent measurement and the older measurement has reached a failure threshold. The sensor is configured to detect red, green, and blue components of light from the backlight and to provide component measurement signals representative of the red, green, and blue components, and the processor is further configured to compare more recent component measurement signals of each of the red, green, and blue components with older component measurement signals and provide the prediction signal of predicted failure when the difference between the more recent measurement and the older measurement of at least one of the components has reached a failure threshold. Further, in another aspect, the processor is further configured to provide the prediction signal of backlight failure when the comparison of measurement signals indicates that the color of the backlight has shifted between the times of measurement by an amount equaling a failure threshold.

In aspects pertaining to a method in accordance with the invention, there is provided a method of predicting failure of a backlight for a display, the method comprising sensing light produced by the backlight, taking color measurements of light from the backlight, and providing measurement signals representative of the light sensed during those color measurements, and comparing a plurality of color measurement signals to each other and providing a prediction signal of failure of the backlight based on a comparison between at least two measurement signals taken at different times. In more detailed aspects, taking color measurements comprises taking measurements of color temperature of the backlight, and comparing comprises measurements of color temperature taken at different times.

In further detailed aspects, taking color measurements comprises detecting color components of light from the backlight, and comparing comprises comparing more recent component measurement signals of each of the components with older component measurement signals of each of the components and providing a prediction signal of predicted failure of the backlight when the difference between the more recent measurement and the older measurement of at least one of the components has reached a failure threshold. In yet a further detailed aspect, detecting color components comprises detecting red, green, and blue color components.

In accordance with yet more detailed aspects of the method, providing a prediction signal of failure of the backlight comprises illuminating a warning light. The method further comprises providing a life-remaining signal to a display based on comparing, the life remaining signal representative of the operational life remaining in the backlight before failure.

The features and advantages of the invention will be more readily understood from the following detailed description which should be read in conjunction with the accompanying drawings.

### BRIEF DESCRIPTION OF THE DRAWINGS

FIG. 1 is a diagram of the front panels of a modular medication infusion system comprising a syringe pump module mounted to a controller. Both the syringe pump module and the controller have at least one LCD used for control of infusion to a patient;

FIG. 2 is a perspective view of a medication storage cabinet having computer control of access to the cabinet with the computer including an LCD in its user interface;

FIG. 3 is a block diagram of a system showing a processor transmitting a warning signal to a communication device in response to a color measurement from a sensor coupled to a backlight and in response to a reference color measurement or measurements stored in a memory device;

FIG. 4 is a diagram of a failure prediction of a backlight showing the failure warning text and a number representing the hours remaining before failure, in a vertical format;

FIG. 5 is a diagram of a failure prediction of a backlight showing the failure warning text and a number representing the hours remaining before failure, in a horizontal format;

FIG. 6 is an enlarged diagram of part of FIG. 1 showing examples of placement of the warnings of FIGS. 4 and 5 on the display of the front panel of a controller, and the locations of warning lights in accordance with FIGS. 7 and 8 below;

FIG. 7 is a diagram showing the use of two warning indicators and associated text, that may be placed on the front panel of a medical device as shown in FIG. 6;

FIG. 8 is a diagram showing the use of a single warning indicator and its associated text, that may be placed on the front panel of a medical device as shown in FIG. 6; and

FIG. 9 is an embodiment of a prediction of the failure of the backlight of an LCD display showing color measurements made, stored, and compared in determining a prediction.

### DETAILED DESCRIPTION OF THE PREFERRED EMBODIMENTS

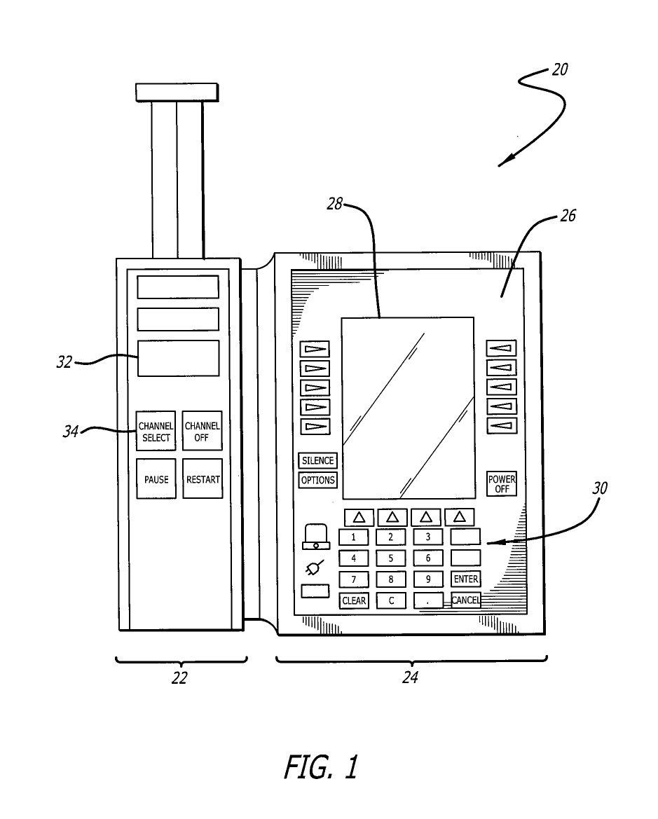

Referring now in more detail to the exemplary drawings for purposes of illustrating embodiments of the invention, wherein like reference numerals designate corresponding or like elements among the several views, there is shown in FIG. 1 a medical device 20 comprising an infusion pump 22, in this case a syringe pump, and a controller 24 having a user interface 26 that includes a liquid crystal display (“LCD”) 28 and a plurality of user input buttons 30. The infusion pump likewise includes at least one LCD 32 and buttons 34 as a user interface. In this case, the controller is used to provide operational control over the syringe pump. It is used to program the syringe pump with operating parameters, compare operating parameters to acceptable limits for particular medications, provide alarms pertaining to incorrect operation under certain conditions, as well as perform other critical tasks relevant to a medical fluid infusion procedure. Setting the operating parameters, selecting the medication for delivery, verifying that parameters have been correctly set, and conveying the reason for certain alarms, are all communicated to an operator through the LCD 28 of the controller 24. If the controller LCD fails, the operator cannot be sure of the pump's configuration or current operational mode and must stop use of the controller and pump until the LCD is repaired or replaced.

Likewise, the infusion pump communicates certain information concerning its operation through the LCD 32 on its front panel. Failure of that pump LCD may leave the operator with a lack of information about the configuration and operation of the pump and an infusion must be delayed until repair or replacement of the LCD. Thus, the loss of either LCD 28 or 32 in this arrangement can result in inoperability of the infusion pump 22 until repair or replacement of that failed LCD. Further details of the operation of such a modular medication system can be found in U.S. Pat. No. 5,713,856 to Eggers entitled “Modular Patient Care System” which is incorporated herein by reference.

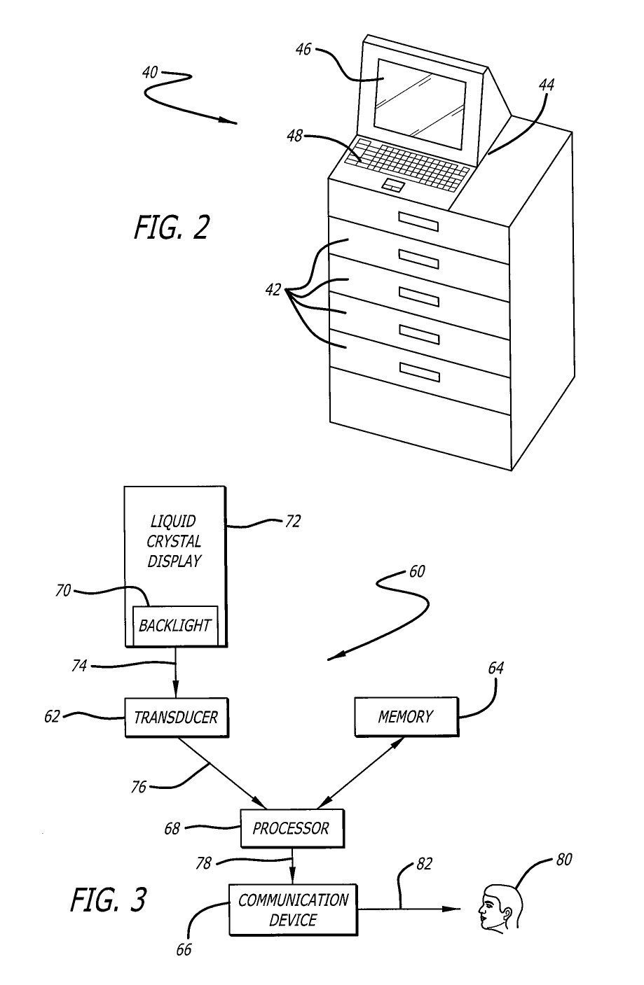

Referring now to FIG. 2, an automated dispensing machine 40 (“ADM”) is shown and comprises a plurality of drawers 42 each of which may contain medications to be administered to patients in accordance with a physician's instructions or orders. The ADM may also store more standard medical care products for which physician orders are not needed for use, and may also store controlled substances, such as narcotics. Access to the drawers to remove medications or other products must be obtained through use of an integral controller 44. The controller also includes a LCD 46 and a keyboard 48 as its user interface. The LCD is used to prompt the user of the ADM to input information, such as a patient identification, nurse identification, order identification, passwords, and other data before the ADM will permit access to a drawer. If the LCD fails, the user of the ADM will not know what information is being requested by the controller and the user will not correctly enter that information for controller verification. The user will therefore not have access to the drawers of the ADM and the ADM will therefore be rendered unusable until the LCD is repaired or replaced.

Medications stored within the ADM 40 having the failed LCD 46 must be transferred to another ADM until repair of the LCD is effected or other means for medication distribution must be used leading to inconvenience at the least. Where the entire nursing shift's medications are stored in a medication station that is controlled by a failed LCD, substantial inconvenience can result. Further details of the operation of such an automated dispensing machine 40 can be found in U.S. Pat. No. 6,116,461 to Broadfield et al. entitled “Method And Apparatus For The Dispensing Of Drugs” which is incorporated herein by reference.

Turning now to FIG. 3, a block diagram of a warning system 60 for producing a warning of the impending failure of a backlight for a liquid crystal display is shown. The warning system comprises a color sensor 62, a memory device 64, and a communication device 66, each of which is in communication with a processor 68. The color sensor is in optical communication with a backlight 70 for a liquid crystal display 72. A common type of backlight is a cold cathode fluorescent lamp (“CCFL”) as discussed above.

As used herein, the term “failure” may be taken to mean broadly that the backlight operation has degenerated to a point where reading the associated LCD has become impossible under normal conditions. It may also encompass the situation where only a part of the backlight has degenerated so that a part of the LCD has become impossible to read under normal conditions. In addition, a failure might mean that the color temperature has shifted sufficiently to render certain color-sensitive displays confusing and mislabeled or invisible such as warnings or alerts.

The color sensor 62 is configured to take a color measurement of light 74 emitted by the backlight 70 and provide a color output 76 representative of that measurement. The color sensor in one embodiment comprises a plurality of photodiodes and color filters and is configured to detect red, green, and blue (“RGB”) components of the light and to provide a voltage output representative of each of the RGB components. Those voltage outputs comprise a color output 76 and are representative of a color measurement. Preferably, the color sensor is a chip or integrated device with integrated red, green, and blue color filters on a 12×12 photodiode array. The photodiode array produces for each color component (RGB) a photocurrent, which is converted to an analog voltage output that increases linearly with increasing light intensity of the color that it detects.

One example of a suitable type of color sensor 62 is the three-color sensor module, HDJD-S831-QT333, from Agilent Technologies of Palo Alto, Calif. This color sensor module has red, green, and blue channels, each of which provides an output voltage. The voltage output levels corresponding to light energy per unit area are influenced by a gain setting for each of the red, green, and blue channels. The gain settings may be changed and carefully selected depending on input requirements of the processor 68 and depending on the level of light energy produced by the type of backlight 70 employed. It will be appreciated that other types of color sensors may be used to provide a color output 76 representative of the color of the LCD backlight.

Regardless of the type of color sensor used, a color value may be derived from the relative voltage outputs corresponding to each of the RGB components. For example, a color value representative of bluish light may be derived when the voltage output for blue is higher than voltage outputs for red and green. Also, a color value representative of yellowish light may be derived when the voltage outputs for red and green are higher than the voltage output for blue. Furthermore, a color value expressed in degrees Kelvin, known as color temperature, may also be derived from the voltage outputs. A color temperature of bluish light will be higher than that of yellowish light. In some cases an increase of or lack of green intensity might predict failure and the display will take on a distinct green or magenta appearance. In this case, color temperature is not applicable.

Still referring to FIG. 3, the processor 68, which receives the color output 76 from the color sensor 62, is configured to communicate the color output to the memory device 64 for storage and future reference. The processor will preferably also store a time marker with the stored color output for reference purposes in determining a trend of color change of the backlight 70 of the LCD 72, although other means for generating and storing a time reference may be used. The memory device is preferably a non-volatile storage device. In storing the color output, the processor may, in one embodiment, store the RGB signals individually, each with a time marker. In another embodiment, the processor may store a color temperature in ° K. and a time marker.

The processor 68 is configured to monitor the color shift of the backlight 70 of the LCD 72 over time and predict a failure of the backlight based on the amount and rate of change of that color shift, in one embodiment. For example, in the beginning of a backlight's serviceable life, the amount of color shift over a time period may be only slight and any shift may occur at a relatively slow rate. Near the end of a backlight's serviceable life, the amount of color shift over the same amount of time will be more extreme and may occur at a much higher rate. Based on the amount of color shift and the rate that the color of the backlight is shifting, as provided by the color sensor 62, the processor will predict failure of the backlight and may extrapolate a predicted date or time for failure or other time measure at which the backlight will fail. The processor will then transmit a backlight information signal 78 to a communication device 66. The communication device will then provide a user 80 with backlight failure information 82 about the backlight, although it may be called “DISPLAY” information of “LCD” information, or other. The communication device is used to warn the user that the backlight of the LCD will fail.

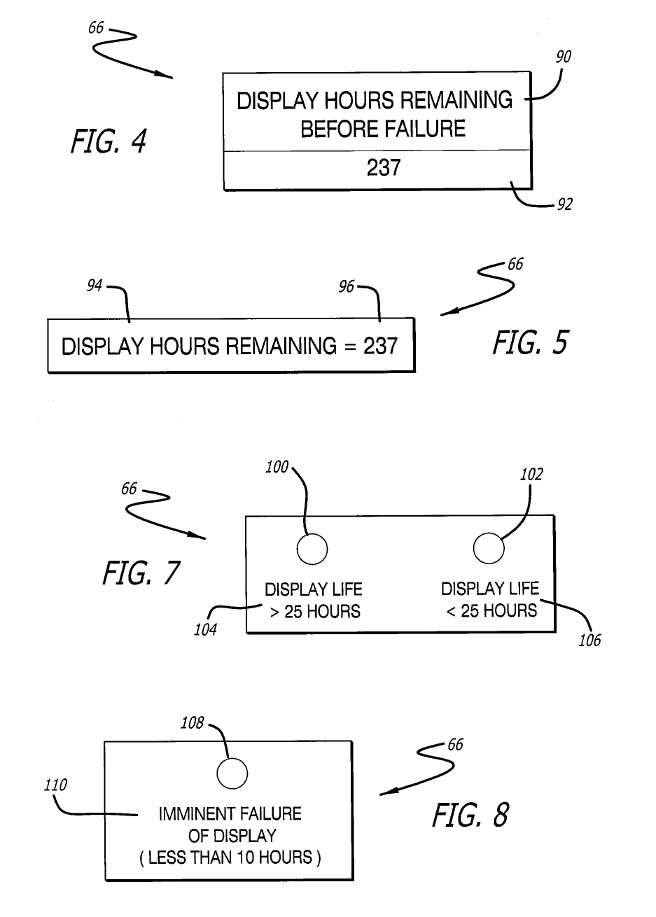

The communication device 66 and the information it provides may take various forms. In the case where the communication device communicates to the user in writing, that written message may be displayed on the same LCD that uses the backlight that the warning system is monitoring. Referring now to FIG. 4, a communication device is shown in the format of a display of “HOURS REMAINING BEFORE FAILURE” 90 and in one embodiment, is displayed on the same LCD 72 that uses the backlight 70 being monitored by the warning system. A numerical indication 92 of the number of hours calculated to remain before display failure is also provided to a user 80. The user 80 is thus permitted to devise a plan for replacement or repair of the display. Other words may be used in place of those in FIG. 4 to accomplish the same result of warning the user of failure of the display. For example, in FIG. 5 the communication device 66 provides the user with the statement “DISPLAY HOURS REMAINING” 94 to indicate the same information as in FIG. 4 but without as many words. A number of hours 96 is also provided in FIG. 5 as in FIG. 4.

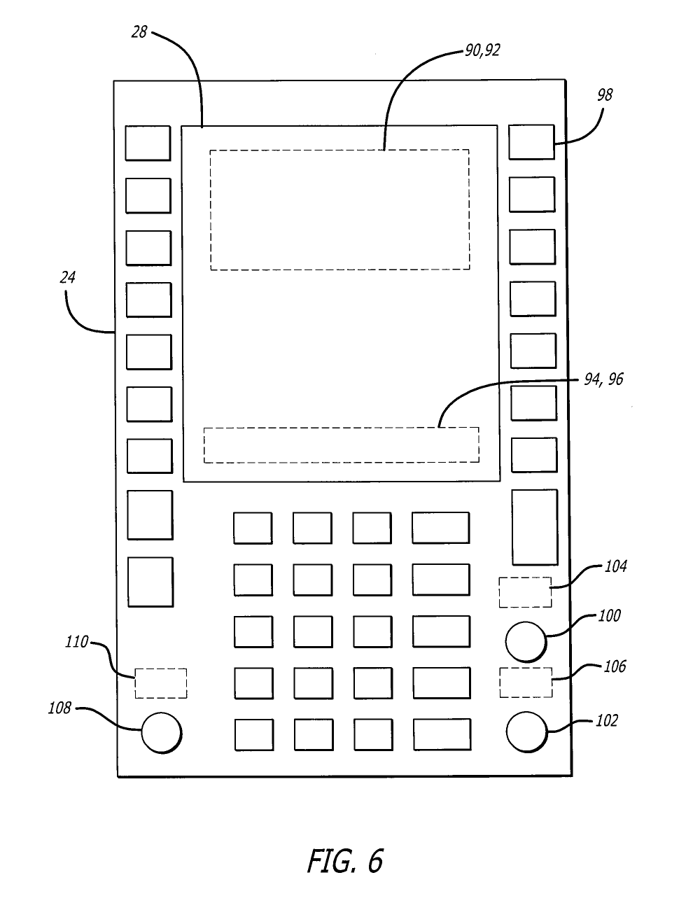

The information displays 66 of FIGS. 4 and 5 may be presented on the very display about which the failure information is warning. In FIG. 6, a larger diagram of part of FIG. 1 is provided. The display 28 is shown and in box 96 at the top of the display screen 28, the information of FIG. 4 may be presented. As discussed above, this information may be briefly and routinely presented at start up of the instrument 24, or may be specifically requested by the user by a key 98 press. The information of FIG. 5 is also shown on the display screen at the bottom of the screen in what may be termed a “status line.” Such a status line may be continually displayed for user review or may scroll periodically, or upon demand, or under other conditions. The status line in FIG. 6 includes the words 94 of FIG. 5 as well as the number of hours remaining 96.

Yet other displays of warning of failure of the backlight of an LCD may be provided to the user. Referring to FIG. 7, a pair of lights 100 and 102 may be used with accompanying legends 104 and 106 respectively. The light above the legend “DISPLAY LIFE>25 HOURS” may be green in color and may be implemented by a light emitting diode or other light source. The light above the legend “DISPLAY LIFE<25 HOURS” may be red in color. Such a scheme of two lights may also be implemented on the front panel of the controller as shown in FIG. 6. In another embodiment as shown in FIG. 8, a single light 108 and accompanying legend 110 may be used. This light is not activated until a certain number of hours remains in the life of a backlight, such as ten hours or fewer 110. As in other embodiments, this embodiment may be implemented on the front panel 26 (FIG. 1) of the controller 24 of FIG. 6. At the lower left, the single warning light 108 is mounted with the explanatory text 110 written above it in this embodiment. The warning light 108 may have only a single color, such as red, or may have multiple colors, such as red and green, that are activated as the situation requires. This light 108 and other lights described above may blink or remain steadily on.

In another embodiment, the text of FIG. 8 (without a light) may be included in a pop-up box displayed on the LCD under software control, the backlight of which is the one with which the pop-up box is concerned. Other text may be displayed, such as:

Imminent Failure of Display—Prefentive Maintenance Required within Five Hours

The software that displays the pop-up box may be a program for running the LCD that is loaded on the local computer or may be a part of a larger operating system associated with more devices than just the LCD. Other arrangements are possible.

Other techniques of displaying warning information about failure of a backlight will become apparent to those skilled in the art. Further, the legends associated with lights or information may refer to failure or life remaining of the “backlight,” the “display,” the “LCD,” or use other designations.

It will be noted that the displays 66 of FIGS. 4 and 5 provide a running and updated number of hours remaining in the life of the backlight; a “countdown” display, where the displays of FIGS. 7 and 8 provide an indication that a threshold has been reached. In another embodiment, the processor may also be configured to calculate the precise date and time that the backlight will fail based on current usage. For example, if the processor has calculated that 237 hours remain in the life of a backlight, and the backlight is presently in use, the processor may calculate that 9 days and 21 hours remain. If the processor has available to it the present date and time, the processor can then calculate the failure date and time based on this information, assuming continuous use. If the backlight is turned off prior to that calculated failure date and time, the processor can calculate a new failure date and time once the backlight is activated again.

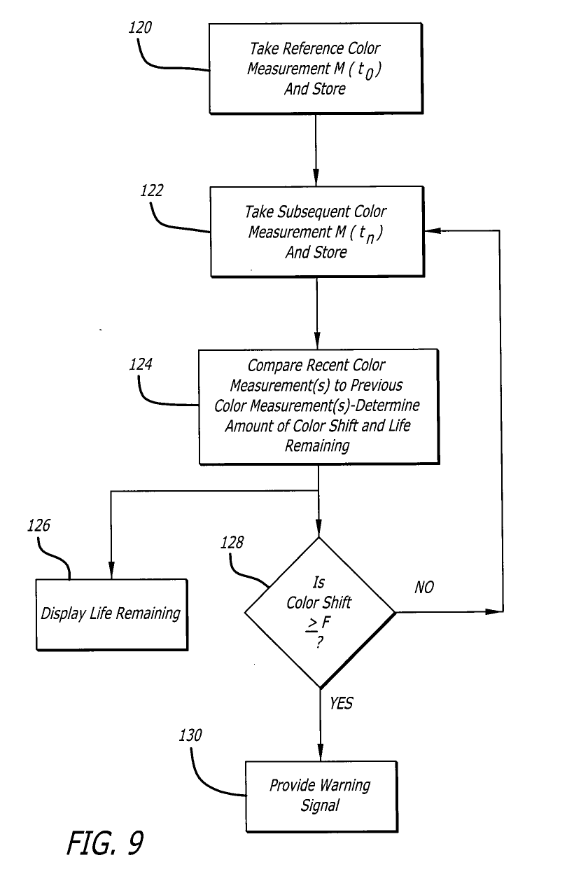

A failure prediction by the processor 68 approximates or models a relationship between the remaining operational life of the backlight 70 and the shift in color temperature of the light it produces. Referring now to FIG. 9, a reference color measurement is taken 120 of light coming from a backlight, such as a cold cathode fluorescent lamp, of a liquid crystal display. Preferably, the reference color measurement is taken early in the life of the backlight, such as soon after the backlight is first installed into the liquid crystal display and is given the designation of M(t0). The reference color measurement, in the form of output voltage levels for RGB color components, a color temperature, or other value representative of color, is stored 120 in a memory for future use.

A subsequent color measurement M (tₙ) of the backlight is taken 122. Preferably, subsequent color measurements M (t_{1, 2 . . . n}) are taken periodically, such as when the backlight is provided power after having been off. The subsequent color measurement may also be taken after a predetermined period of time after the backlight is provided power, such as once every two hours during continual use. Further, the subsequent color measurement may be taken in response to a specific request by a user of the liquid crystal display with which the backlight is associated, such as when a status switch adjacent the liquid crystal display is actuated or when a software command is given. These more current measurements are also stored.

Stored color measurements are compared and a prediction value of the life remaining in the backlight is determined 124 based on at least two of the stored color measurements. In one embodiment, the reference color measurement M (t₀) is used during every comparison of measurement values. In one failure prediction algorithm, the prediction value is merely the difference between the reference color measurement M (t₀) and the subsequent color measurement M (tₙ). For example, where the color measurements are in degrees Kelvin, a simple comparison of the two numbers may be taken:

M(t₀)−M(tₙ)=|D| Eq. 1

where: M is temperature in degrees Kelvin
D is the difference between measured temperatures

The absolute value of D may be compared to a chart of values to predict the remaining life in the backlight. However, the absolute value of D may also be compared to a threshold and if equal to or greater than that threshold, a failure warning signal may be provided to the user:

|D|≧F? Eq. 2

where: D is the difference between measured temperatures
F is the threshold value for failure of the backlight

Based on continually comparing the present color output 76 from the color sensor 62, and stored color outputs sensed by the color sensor previously in time that re stored in the memory 64 device to determine a level of color shift, the processor determines whether to transmit the warning signal of failure. In another embodiment, the processor may continually provide and update an indication of use time remaining before backlight failure.

A more complex failure prediction algorithm may take into account other factors affecting the operational life of the backlight, such as the number of power-on/power-off cycles experienced by the backlight, its age, and the rate of change of the color shift.

A model can be built from empirical data taken from specific illumination sources whereby each of the primary color temperatures can be stored and compared with the last to provide a trend. When the change in, or delta, intensity of each color normalized to the total intensity becomes great enough, the prediction of life will start. This is to allow prediction while allowing for dimming of the backlight so that it can be used in low light conditions.

dPᵣ/dt≧Cᵣ

dP_{g}/dt≧C_{g}

dP_{b}/dt≧C_{b}

Where Pᵣ, P_{g}, and P_{b} are the normalized measured intensities of red, green, and blue components of the illumination. Cᵣ, C_{g}, and C_{b} are constants obtained through experiments depending on the type of the backlight. Normalized power measurements take into consideration the total illumination of all colors. As an example, to normalize Pᵣ, one would use the total power Pₜ=Pᵣ+P_{g}+P_{b} then a ratio metric factor comparing the previous measure to the present measure would be used to normalize the present measurement. Thus, the factor Pₜ₋₁/Pₜ would multiply times the present measurement to normalize it. An example is if the operator decreased the total intensity between the times (t−1) and (t), then the present measurement would be increased so the ratios will be comparable. The periodicity used for measurement could be on the order of minutes or hours with multiple measurements averaged to reduce noise for any given period. If any difference in ratio is measured, a clock would be started and the predicted life would be displayed to the user.

After determining the color shift and a life remaining prediction for the backlight 124, the prediction may be displayed to the user in terms of “life remaining” 126. It may take the form of weeks, days, or hours remaining before the backlight fails, as is shown in FIGS. 4 and 5, or the single value shown in FIGS. 7 and 8. Other indications of life remaining will be apparent to those skilled in the art.

The color shift in the backlight is compared 128 to a predetermined limit or threshold value. If the prediction value is greater than or equal to the threshold value “F,” a warning signal or message is produced 130 to notify a user that the backlight is expected to fail within a period of time. With such notification, the user is given time to replace the backlight so that it does not fail while the liquid crystal display is being used to perform a critical or important task. The predetermined limit or threshold value is selected such that the liquid crystal display may continue to be used for a period of time, such as several hours or a few days, before failure will occur. For example, the predetermined limit or threshold value may correspond to 95% of the operational life of the backlight, such that a warning signal or message indicates that the backlight is expected to fail in about a hundred hours.

If the life remaining prediction value for the backlight 124 fails to reach the threshold value, no warning signal or message is produced and further color measurements are taken and stored 122. The process of comparison is then repeated as shown in FIG. 9.

When the warning of backlight failure is given 130, it may be given in different ways, as discussed in further detail above. In addition to visual warnings, the warning may also be audible, such as through a speaker that broadcasts the warning message as an audible alarm or prerecorded voice message. Other forms of providing the warning will become apparent to those skilled in the art.

In a further embodiment, the results of color temperature measurements and comparisons may be communicated to a remote location, such as a central management location. Failure predictions or warnings may also be automatically communicated to this remote location or others, such as a biotechnician's location. A biotechnician noting the warning of failure may then put into place the replacement process for the backlight. Replacement of the device with the failing backlight may be scheduled.

While several particular forms of the invention have been illustrated and described, it will be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

I claim:

1. A system that predicts failure of a backlight for a display, the system comprising:
a sensor in optical communication with the backlight, configured to take color measurements of light from the backlight, and configured to provide measurement signals representative of the light sensed during those color measurements;
a memory device configured to store color measurements; and
a processor in communication with the sensor and the memory, configured to receive a plurality of measurement signals that have been taken of the backlight at different times, compare a plurality of measurement signals to each other, and to provide a prediction signal of predicted failure of the backlight based on a comparison between at least two measurement signals.

2. The system of claim 1 in which the processor is further configured to:
store measurement signals in the memory device;
access the memory device to retrieve a stored measurement signal;
compare the retrieved measurement signal to a more current measurement signal; and
provide the prediction signal of predicted failure of the backlight based on the comparison between the retrieved measurement signal and the more current measurement signal.

3. The system of claim 1 wherein the processor is further configured to provide a failure warning signal to a display when the result of the comparison exceeds a threshold.

4. The system of claim 1 wherein the processor is further configured to provide a failure warning signal to illuminate a warning light when the result of the comparison exceeds a threshold.

5. The system of claim 1 wherein the processor is further configured to provide a life remaining signal to a display based on the comparison representative of the operational life remaining in the backlight before failure.

6. The system of claim 1 wherein the processor is further configured to provide both a failure warning signal when the result of the comparison exceeds a threshold and a life remaining signal to a display based on the comparison representative of the operational life remaining in the backlight before failure.

7. The system of claim 1 wherein:
the sensor is configured to provide measurement signals representative of the color temperature of the light sensed from the backlight; and
the processor is further configured to compare a more recent color temperature measurement signal of the backlight to an older color temperature measurement signal of the backlight and provide the prediction signal of predicted failure when the difference between the more recent measurement and the older measurement has reached a failure threshold.

8. The system of claim 1 wherein:
the sensor is configured to detect red, green, and blue components of light from the backlight and to provide component measurement signals representative of the red, green, and blue components; and
the processor is further configured to compare more recent component measurement signals of each of the red, green, and blue components with older component measurement signals and provide the prediction signal of predicted failure when the difference between the more recent measurement and the older measurement of at least one of the components has reached a failure threshold.

9. The system of claim 1 wherein the processor is further configured to provide the prediction signal of backlight failure when the comparison of measurement signals indicates that the color of the backlight has shifted between the times of measurement by an amount equaling a failure threshold.

10. A system that predicts failure of a backlight for a display, the system comprising:
a sensor in optical communication with the backlight, configured to detect components of light from the backlight and to provide component measurement signals representative of the components detected;
a memory device configured to store component measurements; and
a processor in communication with the sensor and the memory, configured to receive a plurality of component measurement signals that have been taken of the backlight at different times, compare more recent component measurement signals of each of the components with older component measurement signals of each of the components and provide a prediction signal of predicted failure of the backlight when the difference between the more recent measurement and the older measurement of at least one of the components has reached a failure threshold.

11. The system of claim 10 in which the processor is further configured to:
store component measurement signals in the memory device;
access the memory device to retrieve stored component measurement signals;
compare the retrieved component measurement signals to more current component measurement signals; and
provide the prediction signal of predicted failure of the backlight based on the comparison between the retrieved component measurement signals and the more current component measurement signals.

12. The system of claim 10 wherein the processor is further configured to provide a failure warning signal to illuminate a warning light when the result of the comparison exceeds a threshold.

13. The system of claim 10 wherein the processor is further configured to provide a life remaining signal to a display based on the comparison representative of the operational life remaining in the backlight before failure.

14. The system of claim 10 wherein the processor is further configured to provide both a failure warning signal when the result of the comparison exceeds a threshold and a life remaining signal to a display based on the comparison representative of the operational life remaining in the backlight before failure.

15. The system of claim 10 wherein:
the sensor is configured to provide measurement signals representative of the color temperature of the light sensed from the backlight; and
the processor is further configured to compare a more recent color temperature measurement signal of the backlight to an older color temperature measurement signal of the backlight and provide the prediction signal of predicted failure when the difference between the more recent measurement and the older measurement has reached a failure threshold.

16. The system of claim 10 wherein the sensor is configured to detect red, green, and blue components of light from the backlight and to provide the component measurement signals representative of the red, green, and blue components.

17. A method of predicting failure of a backlight for a display, the method comprising:
sensing light produced by the backlight, taking color measurements of light from the backlight, and providing measurement signals representative of the light sensed during those color measurements; and
comparing a plurality of color measurement signals to each other and providing a prediction signal of failure of the backlight based on a comparison between at least two measurement signals taken at different times.

18. The method of claim 17 wherein:
taking color measurements comprises taking measurements of color temperature of the backlight; and
comparing comprises measurements of color temperature taken at different times.

19. The method of claim 17 wherein:
taking color measurements comprises detecting color components of light from the backlight;
comparing comprises comparing more recent component measurement signals of each of the components with older component measurement signals of each of the components and providing a prediction signal of predicted failure of the backlight when the difference between the more recent measurement and the older measurement of at least one of the components has reached a failure threshold.

20. The method of claim 19 wherein detecting color components comprises detecting red, green, and blue color components.

21. The method of claim 17 wherein providing a prediction signal of failure of the backlight comprises illuminating a warning light.

22. The method of claim 17 further comprising providing a life-remaining signal to a display based on comparing, the life remaining signal representative of the operational life remaining in the backlight before failure.

23. The method of claim 17 wherein the step of providing comprises both providing a prediction signal of failure of the backlight comprising illuminating a warning light and providing a life-remaining signal to a display based on comparing, the life remaining signal representative of the operational life remaining in the backlight before failure.
